(19) United States
(12) Patent Application Publication
(10) Pub. No.: US 2006/0037077 A1
(43) Pub. Date: Feb. 16, 2006

(54) Network intrusion detection system having application inspection and anomaly detection characteristics

(75) Inventors: Ravi Kumar Gadde, Sunnyvale, CA (US); Darshant B. Bhagat, San Jose, CA (US); Ravi Kumar Varanasi, Santa Clara, CA (US)

Correspondence Address: BURGESS & BEREZNAK LLP, 800 WEST EL CAMINO REAL, SUITE 180, MOUNTAIN VIEW, CA, 94040, US

(73) Assignee: Cisco Technology, Inc., San Jose, CA (US)

(21) Appl. No.: 10/919,118

(22) Filed: Aug. 16, 2004

(51) Int. Cl. G06F 12/14

(52) U.S. Cl. 726/23

(57) ABSTRACT

An intrusion detection system and method for a computer network includes a processor and one or more programs that run on the processor for application inspection of data packets traversing the computer network. The one or more programs also obtaining attribute information from the packets specific to a particular application and comparing the attribute information against a knowledge database that provides a baseline of normal network behavior. The processor raises an alarm whenever the attribute information exceeds a predetermined range of deviation from the baseline of normal network behavior. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

The present invention relates generally to digital computer network technology; more particularly, to intrusion detection for network-based computer systems.

### BACKGROUND OF THE INVENTION

With the rapid growth of the Internet and computer network technology in general, network security has become a major concern to companies around the world. The fact that the tools and information needed to penetrate the security of corporate networks are widely available has only increased that concern. Additionally, there is a need for security mechanisms that prevent employees and contractors from unauthorized access to sensitive internal information stored on an organization's internal network. Because of this increased focus on network security, network security administrators often spend more effort protecting their networks than on actual network setup and administration.

Confidential information normally resides in two states on a computer network. It can reside on physical storage media, such as a hard disk or memory of a device such as a server, or it can reside in transit across the physical network wire in the form of packets. A packet is a block of data that carries with it the information necessary to deliver it, analogous to an ordinary postal letter that has address information written on the envelope. A data packet switching network uses the address information contained in the packets to switch the packets from one physical network connection to another in order to deliver the packet to its final destination. Gateways and routers are devices that switch packets between the different physical networks. The format of a packet is usually defined according to a certain protocol. For example, the format of a packet according to the widely-used Internet protocol (IP) is known as a datagram.

These two information states present multiple opportunities for attacks from users on a company's internal network, as well as those users on the Internet. An attack is simply when a person accesses information that they are not authorized to access, or when they attempt to do something undesirable to a network or its resources. By way of example, an IP spoofing attack occurs when an attacker outside of an internal network pretends to be a trusted computer either by using an IP address that is within the range of IP addresses for that network or by using an authorized external IP address that is trusted to access specified network resources.

Application layer attacks exploit well-known weaknesses in software commonly found on servers, such as sendmail, PostScript®, and FTP. By exploiting these weaknesses, attackers can gain access to a computer with the permissions of the account running the application, which is usually a privileged, system-level account. Newer forms of application layer attacks take advantage of the openness of technologies such as the HyperText Markup Language (HTML) specification, web browser functionality, and the HyperText Transfer Protocol (HTTP) protocol. These attacks, which include Java applets and ActiveX controls, involve passing harmful programs across the network and loading them through a user's browser.

A number of different security devices and techniques have been developed to combat the problem of attacks on the security of a corporate network. One type of device that is typically used to control data transfer between an internal, private network and an open, external network such as the Internet is known as a “firewall”. Firewalls are usually routers that are configured to analyze and filter data packets entering an internal network from an external network source. Firewalls may also be utilized to prevent certain information from being passed out of a secure internal network. An example of a conventional firewall system for intrusion detection is disclosed in U.S. Pat. No. 6,715,084. Additionally, U.S. Pat. No. 6,154,775 teaches a computer network firewall that authorizes or prevents certain network sessions using a dependency mask, which can be set based on session data items such as the source host address.

To fully understand how modern firewall systems function, it is necessary to understand the standard architectural model that is often used to describe a network protocol stack. FIG. 1 shows a basic seven layer network protocol stack that provides a common frame of reference for discussing Internet communications. In the model of FIG. 1, each layer defines a data communications function that may be performed by one or more protocols. A dependency exists between the layers. Every layer is involved in sending the data from a local application to an equivalent remote application. Data is passed down the stack from one layer to the next, until it is transmitted over the network by the network access protocols. At the remote end, data is passed up the stack to the receiving application. Each layer in the stack adds control information (e.g., headers and/or trailers) to ensure proper delivery of the data packets.

At the bottom of the stack shown in FIG. 1 is the physical network layer that defines the physical characteristics of the network media. Just above that layer is the data link layer, which provides reliable data delivery across the physical links (such as a wire) of the network. Layer 3 consists of the network access layer, which manages the connections across the network for the upper layers. The protocols as this layer define how to use the network to transmit a frame, which is the basic data unit passed across the physical connection. The most widely-used protocol at this layer is the Internet Protocol (IP), which provides the basic packet delivery service for networks that communicate over the Internet.

The protocol layer directly above the network layer is the host-to-host transport layer, commonly referred to as Layer 4 (“L4”). The L4 protocol layer is responsible for providing end-to-end data integrity and provides a highly reliable communication service for entities that want to carry out an extended two-way conversation. The two most important protocols employed at this layer are the Transmission Control Protocol (TCP) and User Datagram Protocol (UDP). TCP is a connection-oriented protocol that provides end-to-end error detection and correction to ensure reliable service. In contrast, UDP is a connectionless datagram protocol that has no technique for verifying that the data reached the other end of the network correctly.

Above L4 are the session layer, which manages sessions between applications; the presentations layer, which standardizes data presentation to the applications; and the applications layer, which provides functions for users or their programs, and is highly specific to the application being performed. The applications layer is the top layer where user-access network processes reside. Widely known and implemented application layer protocols include File Transfer Protocol (FTP), which performs basic interactive file transfers between hosts; Simple Mail Transfer Protocol (SMTP), which supports basic message delivery services; and HTTP, which supports the low-overhead transport of files consisting of a mixture of text and graphics.

Many existing firewall devices perform deep packet inspection in order to detect standard protocol violations by applying static signatures on various application fields. These application firewall devices basically recognize details of the application running over TCP/UDP and lower level services and detect patterns by searching for unique sequences that match known instances of malicious network traffic. Signature-based or pattern matching intrusion detection is also known as misuse detection. Application firewalling can also be used to detect standard protocol violations, and to perform threshold and buffer overflow checks on various application fields.

One of the drawbacks of these types of application firewall devices is that signature databases must be constantly updated, and the intrusion detection system must be able to compare and match activities against large collections of attack signatures. That is to say, they only operate on known attacks. In addition, if signatures definitions are too specific, or if the thresholds are incorrectly set, these intrusion detection systems may miss variations on known attacks. The application firewall thresholds and signatures also need to be configured for each branch/installation of the network. For a large corporation (e.g., an international bank) the overhead associated with maintaining the signature database information can be costly.

Profile-based intrusion detection, sometimes called anomaly detection, is another security methodology that has been used to detect malicious network activity. Anomaly detection systems examine ongoing network traffic, activity, transactions, or behavior for anomalies on networks that deviates from a “normal” host-host communications profile. By keeping track of the services used/served by each host and the relationships between hosts, anomaly-based intrusion detection systems can observe when current network activity deviates statistically from the norm, thereby providing an indicator of attack behavior.

By way of further background, U.S. Pat. No. 6,681,331 teaches a dynamic software management approach to analyzing the internal behavior of a system in order to assist in the detection of intruders. Departures from a normal system profile represent potential invidious activity on the system. U.S. Pat. No. 6,711,615 describes a method of network surveillance that includes receiving network packets (e.g., TCP) handled by a network entity and building long-term and short-term statistical profiles. A comparison between the building long-term and short-term profiles is used to identify suspicious network activity.

The problem with conventional anomaly detection systems, however, is that they only examine activity up to the network transport layer, i.e., L4. Many of the newer computer viruses, such as Internet “worms” that surreptitiously convert a computer to an attacker's purpose of propagating malicious software, have different code patterns and behaviors that are undetectable at this layer of the network protocol stack. Furthermore, because normal behavior can change easily and readily, anomaly-based IDS systems are prone to false positives where attacks may be reported based on events that are in fact legitimate network activity, rather than representing real attacks. (A false negative occurs when the IDS fails to detect malicious network activity. Similarly, a true positive occurs when the IDS correctly identifies network activity as a malicious intrusion; a true negative occurs when the IDS does not report legitimate network activity as an intrusion.) Traditional anomaly detection systems can also impose heavy processing overheads on networks.

In view of the aforementioned problems in the prior art there remains an unsatisfied need for an improved intrusion detection systems and method capable of detecting today's sophisticated worm attacks and other malicious network activity.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a prior art model of a network protocol stack.

FIG. 2 shows a basic network architecture with intrusion detection in accordance with one embodiment of the present invention.

FIG. 3 is an example that illustrates deep packet inspection at the applications layer in accordance with one embodiment of the present invention.

FIG. 4 illustrates a template utilized in accordance with one embodiment of the intrusion detection system present invention.

FIG. 5 is a flowchart showing a method of network operation according to one embodiment of the present invention.

FIG. 6 is a circuit block diagram showing the basic architecture of a network intrusion detection device according to one embodiment of the present invention.

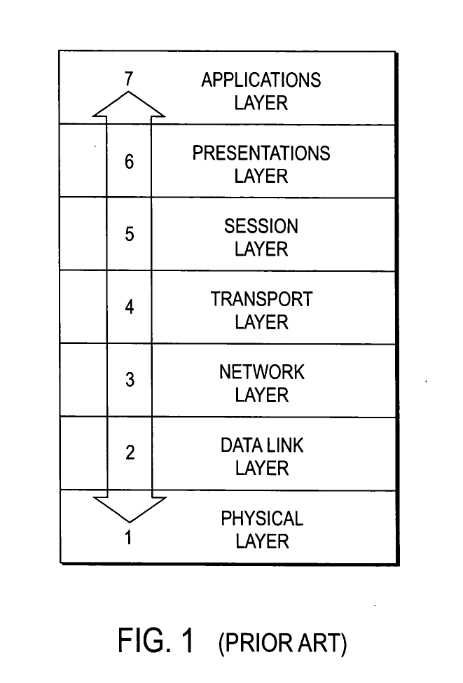

### DETAILED DESCRIPTION

A network-based system and method is described that combines features of application firewalling and anomaly detection to provide a comprehensive, pervasive security solution for combating unauthorized intrusions, malicious Internet worms, along with bandwidth and e-Business application attacks. In the following description specific details are set forth, such as device types, protocols, configurations, etc., in order to provide a thorough understanding of the present invention. However, persons having ordinary skill in the networking arts will appreciate that these specific details may not be needed to practice the present invention.

In the context of the present application, it should be understood that a computer network is a geographically distributed collection of interconnected subnetworks for transporting data between nodes, such as intermediate nodes and end nodes. A local area network (LAN) is an example of such a subnetwork; a plurality of LANs may be further interconnected by an intermediate network node, such as a router or switch, to extend the effective “size” of the computer network and increase the number of communicating nodes. Examples of the end nodes may include servers and personal computers. The nodes typically communicate by exchanging discrete frames or packets of data according to predefined protocols. In this context, a protocol consists of a set of rules defining how the nodes interact with each other.

Each node typically comprises a number of basic subsystems including a processor, a main memory and an input/output (I/O) subsystem. Data is transferred between the main memory (“system memory”) and processor subsystem over a memory bus, and between the processor and I/O subsystems over a system bus. Examples of the system bus may include the conventional lightning data transport (or hyper transport) bus and the conventional peripheral component interconnect (PCI) bus. The processor subsystem may comprise a single-chip processor and system controller device that incorporates a set of functions including a system memory controller, support for one or more system buses and direct memory access (DMA) engines. In general, the single-chip device is designed for general-purpose use and is not heavily optimized for networking applications.

In a typical networking application, packets are received from a framer, such as an Ethernet media access control (MAC) controller, of the I/O subsystem attached to the system bus. A DMA engine in the MAC controller is provided a list of addresses (e.g., in the form of a descriptor ring in a system memory) for buffers it may access in the system memory. As each packet is received at the MAC controller, the DMA engine obtains ownership of (“masters”) the system bus to access a next descriptor ring to obtain a next buffer address in the system memory at which it may, e.g., store (“write”) data contained in the packet. The DMA engine may need to issue many write operations over the system bus to transfer all of the packet data.

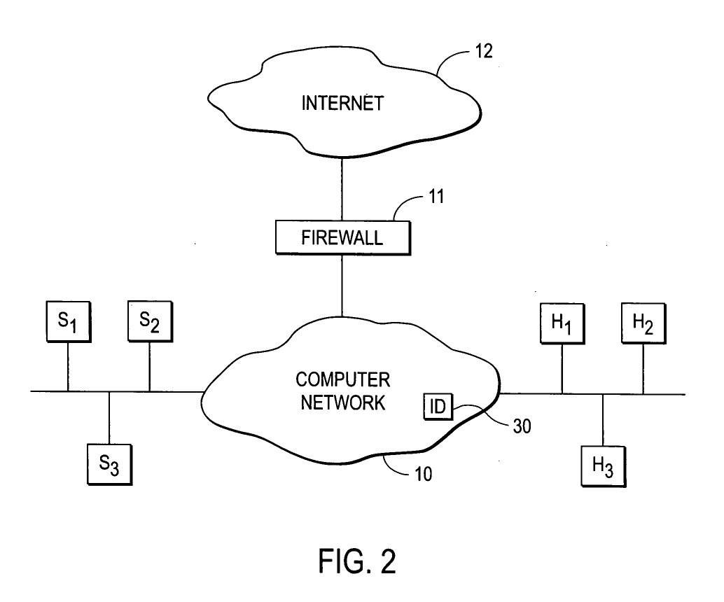

With reference now to FIG. 2, there is shown an exemplary system in accordance with one embodiment of the present invention that includes an internal computer network 10 connected to an outside network (e.g., the Internet) 12 through a firewall device 11. Computer network 10 includes connections to a set of host devices (e.g., desktop computers, workstations, laptops, etc.) H₁-H₃, as well as servers S₁-S₃. Also included in the diagram of FIG. 2 is an intrusion detection (ID) device 30 that embodies intrusion detection firmware/software with application inspection (AI) and anomaly detection (AD) functionality in accordance with the present invention. Alternatively, ID device 30 can be incorporated into firewall device 11, or one or more of the server/host devices. In still other embodiments, the method of intrusion detection according to the present invention may be implemented in machine-readable code stored in firmware, software, on a hard disk, etc. for execution on a general purpose processor.

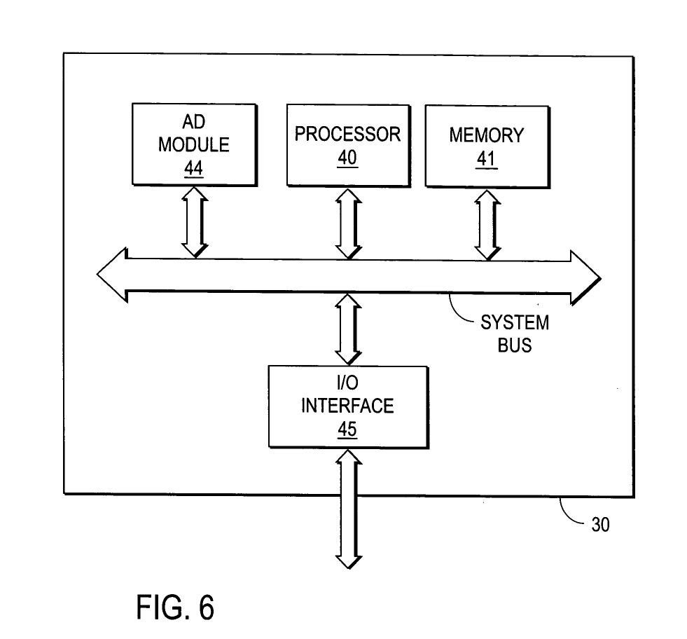

FIG. 6 is a conceptual block diagram showing an exemplary ID device 30 that includes a processor 40 coupled with a memory unit 41, anomaly detection (AD) module 44, and an input/output (I/O) interface 45 comprising a plurality of port modules. ID device 30 may also include an application inspection (AI) module (not shown in FIG. 6) for performing deep packet inspection on packets traversing the network. Alternatively, application inspection functionality may be implemented in programs and routines executed by processor 40. Practitioners in the art will understand that in most implementations AD module 44 comprises a software program that is executed by processor 40, as opposed to a separate hardware device coupled to the system bus as shown in FIG. 6. That is, the AD and AI modules typically both comprise software programs or routines that run on one or more processors associated with device 30.

Alternatively, the AD and AI modules may be implemented as separate hardware devices, memory locations (storing executable code), firmware devices, or other machine-readable devices. Data and/or instructions are transferred between memory unit 41 and processor 40, and between the processor 40 and I/O interface 45 over a system bus. (In the context of the present application, therefore, the term “module” is to be understood as being synonymous with both hardware devices and computer-executable software code, programs or routines.) Other implementation may include a separate memory bus coupled between memory unit 41 and processor 40. It is appreciated that processor 40 may comprise a single-chip processor, or a multi-processor system optimized for networking applications.

For example, for each host intrusion detection network device 30 maintains a data profile listing which network agents and devices the host normally communicates with during a given time of day. The ID system penetrates the packets traversing the network to generate and then maintain a knowledge database of normal behavior for a given host running a particular application. By examining data packet traffic at a deep level, i.e., above L4, the ID system of the present invention can identify and halt an attack in progress that deviates from the established norm using a set of learned or programmed policies.

To put it another way, penetrating the data packets at the applications layer level allows the present invention to solve the problem of surreptitious attacks that would normally pass into an organization's network undetected by prior art intrusion detection systems. An example of such an attack is a computer worm virus that tunnels into a corporate network in which HTTP is purposefully left open. The worm may enter the network, for instance, using Yahoo® messenger through HTTP. Such an attack would normally go undetected by prior art intrusion detection systems since the tunneling of Yahoo® messenger through HTTP is indistinguishable from normal web traffic in such systems. The specific intelligence provided by the present invention, however, stop this type of attack by identifying the improper or abnormal use of Yahoo® messenger encapsulated in HTTP.

To better understand the present invention, consider an example of a bank having an internal network and a head office that deals in large corporate accounts with huge thresholds for withdrawal/transfers. A branch office in a remote town deals in small personal accounts having much lower transaction amounts. The system of the present invention utilizes anomaly detection techniques to establish normal (e.g., mean, standard deviation, etc.) transaction amounts for a given time of day for various users/hosts. Application firewall (synonymous with application inspection) techniques are also used to automatically compute a relevant threshold or set of policies so that a firewall device located at a small branch can issue an alarm when a substantially large transaction is detected (and possibly reroute the transaction to the head office).

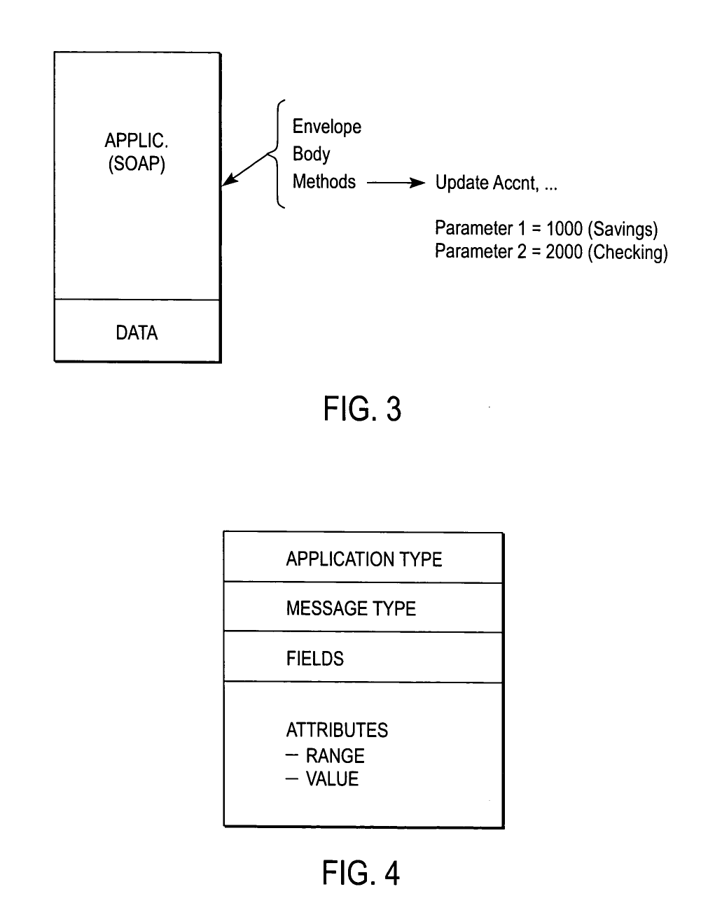

FIG. 3 shows a more detailed example in which Simple Object Access Protocol (SOAP) methods and parameters are monitored on a bank's server at the application level. Practitioners in the computer arts will understand that SOAP is a known Extensible Markup Language (XML) based protocol for exchanging structured information between distributed applications over native web protocols such as HTTP. SOAP is a common method of communications for accessing web services and transactions, and is often used for handling bank account transactions. In accordance with the present invention, packets are inspected at the application level (i.e., above HTTP) to examine the SOAP envelope message. In this example, a SOAP message contains a method (called “update account”) that has been sent to the bank by a client for the purpose of updating certain parameters of the account. (Alternatively, the message may have originated from someone having internal access to the bank's network devices and resources.)

According to the present invention, the parameter values (e.g., Parameter₁=1000; Parameter₂=2000) are extracted using standard application inspection routines and input into an AD module which maintains a database structure specific to this SOAP message. Based on previously learned behavior for this method, the AD module will have established a normal parameter value range for Parameter₁ and Parameter₂. By way of example, from learned behavior the particular range of normal activity for Parameter₁ may be, say, 5 to 500. Because this particular transaction (i.e., $1000 to savings account) exceeds the upper bound of known normal activity, the system of the present invention responds to this message by triggering an alarm.

In another example, various fields and parameters may be monitored on a Simple Mail Transfer Protocol (SMTP) server. In such a deployment scenario, application inspection and anomaly detection techniques may be combined in the ID system of the present invention to maintain an email profile for the entire network. For instance, the ID system may learn that 10% of all attachments are .doc files and less than 0.1% are .pdf files. In the case of a virus outbreak which starts to spread .pdf files in emails, the system would respond by triggering an alarm.

It is appreciated that the fields and parameters examined in the system and method of the present invention may vary between different applications. That is, the fields and attributes are tailored to the data packets being tracked for a specific application. The AD module tracks the value ranges and establishes a baseline of normal network behavior for the various fields and attributes chosen. Furthermore, the process of selecting fields and ranges and/or values to be used for each method may be automated. For example, the overhead normally associated with configuring an application firewall device may be obviated in accordance with the present invention by using the anomaly detection module to automatically configure and establish appropriate limits/thresholds through a learning process. Alternatively, the parameters and values that are monitored for a certain application may be fixed or defined globally. Yet another possible implementation allows the application users to define the set of parameters to be learned and monitored.

FIG. 4 illustrates a modifiable template that defines methods used for a particular application according to one embodiment of the present invention. By way of example, for HTTP the application type and message types may each consist of an integer value. The message type value designates the specific type of message in the application. The field entry of the template denotes the specific fields in the application that are to be examined. The attributes can be of several types and are not just limited to range (i.e., maximum and minimum values) and value (e.g., string, Boolean, integer, etc.) attributes.

Using the template shown in FIG. 4, the ID system of the present invention utilizes application inspection to input information in to the AD module regarding a particular method. After a knowledge base of network activity has been created, the AD module will raise an alarm when current behavior is observed that deviates statistically from the norm. Examples of such behavior may include when the string “PUT” is seen for the first time for a particular IP address, or when the number of “PUT” strings rises significantly for an IP address, or when “PUT” is observed being sent to a server that is not an HTTP server. For each these examples, the template of FIG. 4 may be set as follows: application type: HTTP; message type: request; fields: MethodName; attribute-value: PUT.

For the previous bank transaction example, the monitoring template may be set as: application type: SOAP; message type: <SoapEnvelope>; fields: doTransaction.Parameter₁; attribute-value: 5-500. Using this template, application inspection routines can input information regarding a particular SOAP method used on a server as well as statistical information concerning normal variations in Parameter₁. Upon detection of a value for Parameter, that is out of the ordinary or normal range, the AD module raises an alarm indicating an anomaly. Similarly, if the method doTransaction is invoked on a particular server where it had never been invoked previously, anomaly detection may generate an alarm.

Practitioners in the computer networking arts will appreciate that in certain implementations, the AD module may specify, for each host, a list of services together with a list of neighbors and the relations that host has with its neighbors. (In the context of this discussion, it should be understood that the services comprise a list of L4 services used/served by the host; the neighbors comprise a list of hosts that a particular host normally communicates with, and the relations comprise a list of services between the two hosts and the client-server relationship.) Associated with each service in the AD module, an Application Program Interface (API) between the operating system and applications program can be utilized by the application inspection module (or routine) to register the application specific module of interest. For each of these applications, several data structures may be utilized to maintain a baseline of normal behavior. For example, for HTTP, counters based on the hash of Uniform Resource Locators (URLs) served by the host can be maintained. Alternatively, a list of SOAP methods and parameters can be maintained. As previously described, the application inspection module analyzes applications and provides relevant information to the application specific AD module, which processes this information to detect abnormal use of applications and take corrective actions obviating the need for signatures or pattern matching.

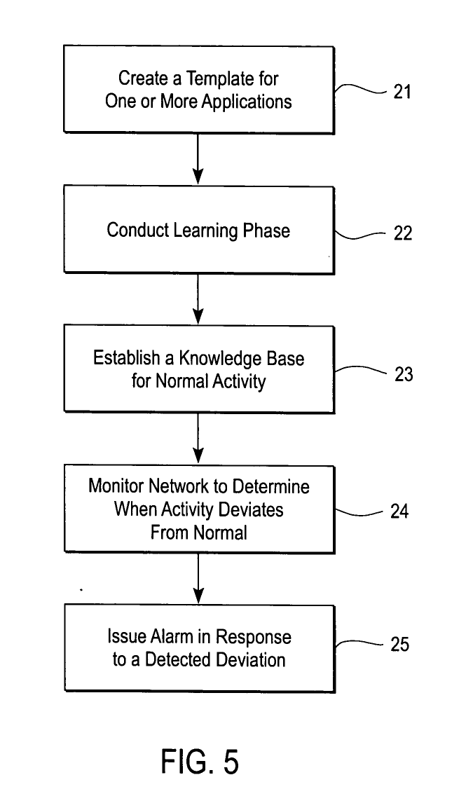

FIG. 5 is a flowchart describing a basic method of operation according to one embodiment of the present invention. The method of FIG. 5 begins at block 21 with the creation of a template, such as the one shown in FIG. 4, tailored to the particular application being tracked. As previously discussed, the template information defines the methods used for a specific application, along with the fields and parameters that are to be monitored. It is appreciated that the network ID device of the present invention may utilize multiple different templates when examining packets traversing the network.

Once the templates have been created for one or more applications, a learning phase is conducted (block 22). Learning involves the process of gathering information about normal network activity over a period of time (e.g., 4-6 hours) for the purpose of creating an activity baseline. During this phase, thresholds and attribute ranges and values may also be learned. That is the AI module or routines may provide information to the AD module that can be used to establish an normal range, or acceptable deviation from the norm, for the parameters of interest for a particular application. Alternatively, the threshold levels can be set globally by software programs running on the network. It should also be understood that the learning phase may be repeated at regular intervals to update and track normal changes in host relations and network activity. In other words, the knowledge base of normal activity need not be static; it may evolve over time as the network is reconfigured, expands, new users are added, etc.

After the learning phase has been completed, the ID device continuously monitors the network to detect anomalous user behavior that exceeds the established norms. This step is shown occurring at block 24. By creating baselines of normal behavior, the AD module can observe when current behavior deviates statistically from the norm, and issue an alarm in response (block 25). Because the method of the present invention examines activity at the application level (i.e., above L4), it is able to able to detect and stop surreptitious computer virus and malicious intruder attacks that would ordinarily go undetected using prior art ID systems.

It should also be understood that elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer (e.g., a server) to a requesting computer (e.g., a customer or client) by way of data signals embodied in a carrier wave or other propagation medium via a communication link (e.g., a modem or network connection).

Furthermore, although the present invention has been described in conjunction with specific embodiments, those of ordinary skill in the computer networking arts will appreciate that numerous modifications and alterations are well within the scope of the present invention. Accordingly, the specification and drawings are to be regarded in an illustrative rather than a restrictive sense.

We claim:

1. An intrusion detection device for a computer network comprising:
a processor;
one or more programs that run on the processor for inspecting packets traversing the computer network at an application level, the one or more programs obtaining attribute information from the packets specific to a particular application for comparison against a knowledge database that provides a baseline of normal network behavior for the attribute information specific to the particular application,
wherein the processor raises an alarm when the attribute information exceeds a predetermined range of deviation from the baseline of normal network behavior.

2. The intrusion detection device of claim 1 wherein the one or more programs comprise application inspection and anomaly detection software programs.

3. The intrusion detection device of claim 1 wherein the anomaly detection program is configured to automatically establish the predetermined range of deviation through a learning process.

4. The intrusion detection device of claim 1 wherein the attribute information includes parameter values associated with a method of the particular application.

5. An intrusion detection device for a computer network comprising:
one or more processors;
a program that runs on the processor for inspecting packets traversing the computer network at an application level, the program obtaining attribute information from the packets specific to a particular application for comparison against a knowledge database that provides a baseline of normal network behavior for the attribute information specific to the particular application,
wherein the one or more processors raises an alarm when the attribute information exceeds a predetermined range of deviation from the baseline of normal network behavior.

6. The intrusion detection device of claim 5 wherein the program comprises application inspection and anomaly detection software routines.

7. The intrusion detection device of claim 5 wherein the anomaly detection software routine is configured to automatically establish the predetermined range of deviation through a learning process.

8. The intrusion detection device of claim 5 wherein the attribute information includes parameter values associated with a method of the particular application.

9. A computer-implemented method for intrusion detection on a computer network comprising:
creating a template that includes fields and attributes specific to a particular application;
establishing a knowledge base of normal network activity at an application level for the computer network;
monitoring packet traffic on the computer network at the application level to detect when attribute information associated of a packet exceeds a specified range and/or threshold about a behavioral norm contained in the knowledge base for the particular application; and
issuing an alarm when the attribute information exceeds the specified range and/or threshold.

10. The computer-implemented method of claim 9 further comprising:
automatically computing the specified range and/or threshold for the particular application from the knowledge base of normal network activity.

11. The computer-implemented method of claim 9 wherein establishing a knowledge base of normal network activity comprises:
gathering information about normal network activity over a predetermined period of time.

12. The computer-implemented method of claim 9 wherein the attribute information includes parameter values associated with a method of the particular application.

13. A computer program product comprising a computer useable medium and computer-readable code embodied on the computer useable medium, execution of the computer readable code causing a computer network device to:
monitor packet traffic on a computer network at an application level;
detect when attribute information associated of a packet exceeds a specified range and/or threshold about a behavioral norm contained in a knowledge base associated with a particular application; and
issue an alarm when the attribute information exceeds the specified range and/or threshold.

14. The computer program product of claim 13 wherein execution of the computer-readable code further causes the computer network device to:
gather information at an application level about normal network activity over a predetermined period of time; and
establish a knowledge base of normal network activity using the information gathered at the application level.

15. The computer program product of claim 13 wherein execution of the computer-readable code further causes the computer network device to:
periodically update the knowledge base of normal network activity.

16. An intrusion detection system for a computer network comprising:
means for inspecting data packets at an application network protocol level and for extracting information that includes one or more parametric values associated with a method of a particular application;
means for examining ongoing data packet traffic of the computer network to identify anomalies and for detecting when the one or more parametric values associated with the method of the particular application deviates from a baseline of normal network traffic, activity, transactions, or behavior, an alarm being raised in response thereto.

17. The intrusion detection system of claim 16 wherein a deviation is detected and the alarm raised when the one or more parametric values exceeds a predetermined threshold and/or range.

18. The intrusion detection system of claim 16 further comprising means for creating the baseline by monitoring the network traffic, activity, transactions, or behavior over a period of time.

19. The intrusion detection system of claim 16 further comprising means for automatically establishing the predetermined threshold and/or range through a learning process.
